(19) United States
(12) Patent Application Publication
(10) Pub. No.: US 2008/0291538 A1
(43) Pub. Date: Nov. 27, 2008

(54) Plasma reflective polarizer

(75) Inventors: Ta-Jen Yen, Hsinchu County (TW); Yu-Hang Yang, Kaohsiung City (TW)

Correspondence Address: Joe McKinney Muncy, PO Box 1364, Fairfax, VA, 22038-1364, US

(73) Assignee: National Tsing Hua University

(21) Appl. No.: 11/802,871

(22) Filed: May 25, 2007

(51) Int. Cl. G02B 5/30

(52) U.S. Cl. 359/486; 359/483

(57) ABSTRACT

The present invention discloses a plasma reflective polarizer, which comprises a transparent substrate and a metal-line film. The metal-line film is formed via periodically disposing metal lines on the transparent substrate. Alternatively, the plasma reflective polarizer of the present invention comprises a plurality of transparent substrates stacked one above one; each transparent substrate has a metal-line film, and the metal-line film is formed via periodically disposing metal lines on the transparent substrate. The plasma reflective polarizer of the present invention is a simple structure formed of only a common transparent substrate and a metal-line film. Therefore, the present invention is a low-cost plasma reflective polarizer having a high brightness-enhancing function and superior mechanical properties.

### FIELD OF THE INVENTION

The present invention relates to a plasma reflective polarizer, particularly to a polarizer, which utilizes the plasma line-induced electromagnetic-wave polarization to implement a high-pass filtering function and reflects light for recycling to enhance the brightness of an LCD panel.

### BACKGROUND OF THE INVENTION

Owing to the progress of science and technology, the fabrication technology of LCD (Liquid Crystal Display) has been mature, and LCD has been the mainstream product in FPD (Flat Panel Display) field and has the highest product value.

Although LCD is not so good as the traditional CRT (Cathode Ray Tube) in brightness, image quality, response speed and cost, LCD still has the advantages of compactness, light weight, low power consumption and no electromagnetic interference. With the persistent advance of technology, LCD will replace CRT in the long run.

An LCD panel is composed of a color filer, a common electrode, a glass substrate, a polarizer, etc. The LCD panel itself is a non-luminous device and needs an external light source to display images. The light sources thereof include the front light source and the back light source. At present, most of LCD panels adopt the back-light type BLM (BackLight Module), wherein light injects into an LCD panel from the bottom thereof.

Refer to FIG. 1. The LCD backlight module usually adopts the edge-light structure, which comprises a light guide plate 11, a CCFL (Cold Cathode Fluorescent Lamp) 13, a diffuser 14 and a reflector 15. The light guide plate 11 is used to guide light propagation, increase the brightness of the panel and control the uniformity of the brightness, wherein diffusion points 12 with different sizes and different distribution densities are used to make the light-output face of the light guide plate 11 emit light uniformly. The CCFL 13 is arranged at the thicker end of the light guide plate 11. After light enters the light guide plate 11, most of light will be transmitted toward the thinner end of the light guide plate 11 because of total reflection. When light hits on the diffusion points 12 on the bottom of the light guide plate 11, light will be reflected and scattered. Thus, total reflection stops, and light is emitted from the front face of the light guide plate 11. The diffuser 14 is used to make the light emitted by the light guide plate 11 more uniform; thus, the shadow of reflection points will not be perceived from the front face. The reflector 15 is used to reflect the leakage light back to the light guide plate 11 to increase light efficiency.

The light output by the diffuser 14 has a poor directivity; therefore, a brightness enhancement film is usually used to converge the large-angle scattered light back to the normal direction. Refer to FIG. 2. A U.S. Pat. No. 5,161,041 disclosed a “Brightness Enhancement Film (BEF) 20”, which has a prismatic structure with a vertex angle of 90 degrees, wherein the large-angle scattered light is converged to the range near the normal direction by the refraction phenomenon, which obeys the Snell's Law. Thereby, the brightness is promoted in the normal direction.

The abovementioned technology has a disadvantage: the light near the normal direction originally will be totally reflected in the prismatic structure and then returns to the bottom reflector 15 for recycling. However, light must be obviously attenuated after traveling through such a long path. Therefore, the BEF 20 is only effective for the large-angle scattered light. The BEF 20 has none practical effect on the light originally small-angle scattered; or worse, it may even degrade the light efficiency thereof.

Refer to FIG. 3. A U.S. Pat. No. 5,828,488 disclosed a “Dual Brightness Enhancement Film (DBEF)” to solve the abovementioned problem, wherein about one thousand pieces of birefringence polymer films A and B are used to form an optical film with a thickness of only 130 μm—a reflective polarizer 30. The reflective polarizer 30 not only has the polarization effect of the conventional polarizer but also can effectively reflect the non-penetrating polarized light back to the backlight module for recycling. As the bottom reflector of the backlight module has the diffusion and scatter effect, the original non-penetrating polarized light is converted into the penetrating polarized light. After the repetition of the abovementioned process, most of the light originally to be absorbed and wasted is converted into useful light, which not only can promote the brightness of the backlight module by about 60% but also the brightness promotion is effective over the whole viewing angle. Further, the cooperation of the reflective polarizer 30 and the conventional BEF 20 can even promote the brightness of the backlight module by 160%.

The abovementioned DBEF has a superior performance. However, it has a big disadvantage—a too high cost. Besides, the DBEF has poor mechanical properties, and the brightness is easily influence by the angle of the incident light.

### SUMMARY OF THE INVENTION

The primary objective of the present invention is to provide a simple-structure and low-cost plasma reflective polarizer, which is formed of only a common transparent substrate and a metal-line film and has a superior brightness-enhancement function and good mechanical properties.

The present invention proposes a plasma reflective polarizer, which comprises a transparent substrate and a metal-line film. The metal-line film is formed via periodically disposing metal lines on the transparent substrate. Alternatively, the plasma reflective polarizer of the present invention comprises a plurality of transparent substrates stacked one above one; each transparent substrate has a metal-line film, and the metal-line film is formed via periodically disposing metal lines on the transparent substrate. The material of the metal-line film is selected from the group consisting of gold, silver, copper and aluminum. The metal-line film has a thickness of between 50 and 300 nm. The spacing between two neighboring metal lines is between 50 and 500 nm.

The plasma reflective polarizer of the present invention utilizes the electromagnetic-wave polarization induced by the metal-line film and the special electromagnetic effect—plasma frequency phenomenon of metallic materials. When the frequency of an electromagnetic wave is higher than that of plasma, the electromagnetic wave will penetrate the metallic material. When the frequency of an electromagnetic wave is lower than that of plasma, the electromagnetic wave will not penetrate the metallic material. Therefore, the plasma reflective polarizer itself can function as a high-pass filter. Besides, the metal-line film can reflect the light that does not penetrate. The light reflected by the metal-line film is reflected once again by the reflector and polarized by the metal-line film to enhance brightness.

### BRIEF DESCRIPTION OF THE DRAWINGS

FIG. 1 is a diagram schematically showing the structure of an edge-light backlight module.

FIG. 2 is a diagram schematically showing the Brightness Enhancement Film disclosed in the U.S. Pat. No. 5,161,041.

FIG. 3 is a diagram schematically showing the Dual Brightness Enhancement Film disclosed in the U.S. Pat. No. 5,828,488.

FIG. 4 is a diagram schematically showing the structure of the plasma reflective polarizer according to the present invention.

FIG. 5 is a diagram schematically showing that the present invention is applied to an edge-light backlight module.

FIG. 6 is a diagram schematically showing the light penetration according to the present invention.

FIG. 7 is a diagram schematically showing the triple-layer structure plasma reflective polarizer according to the present invention.

FIG. 8 is a diagram showing the relationship between penetration capability and frequency in the case that the electric field (E) of light is parallel to the metal lines.

FIG. 9 is a diagram showing the relationship between penetration capability and frequency in the case that the electric field (E) of light is vertical to the metal lines.

FIG. 10 is a diagram showing the relationships between penetration capability and frequency in the cases that the spacing (a) between two neighboring metal lines varies.

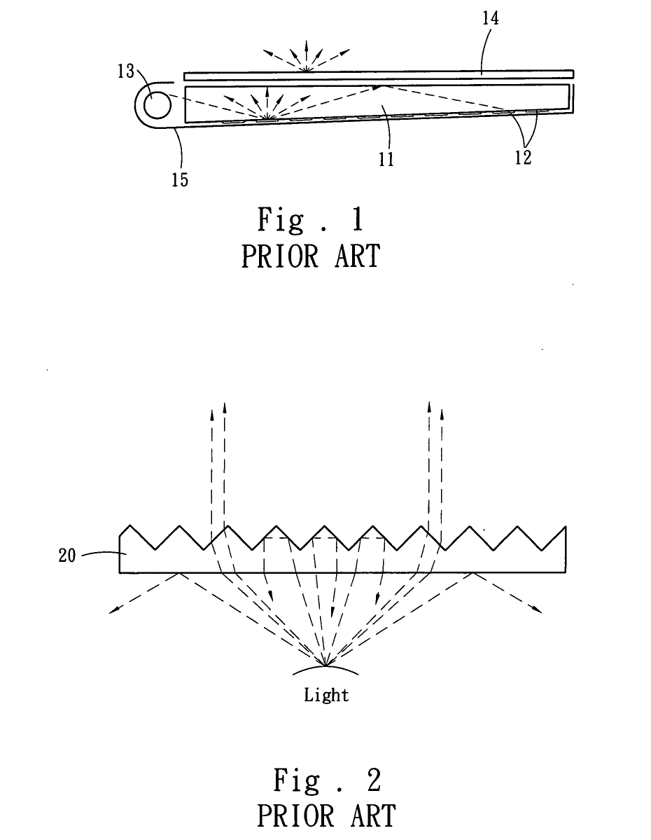

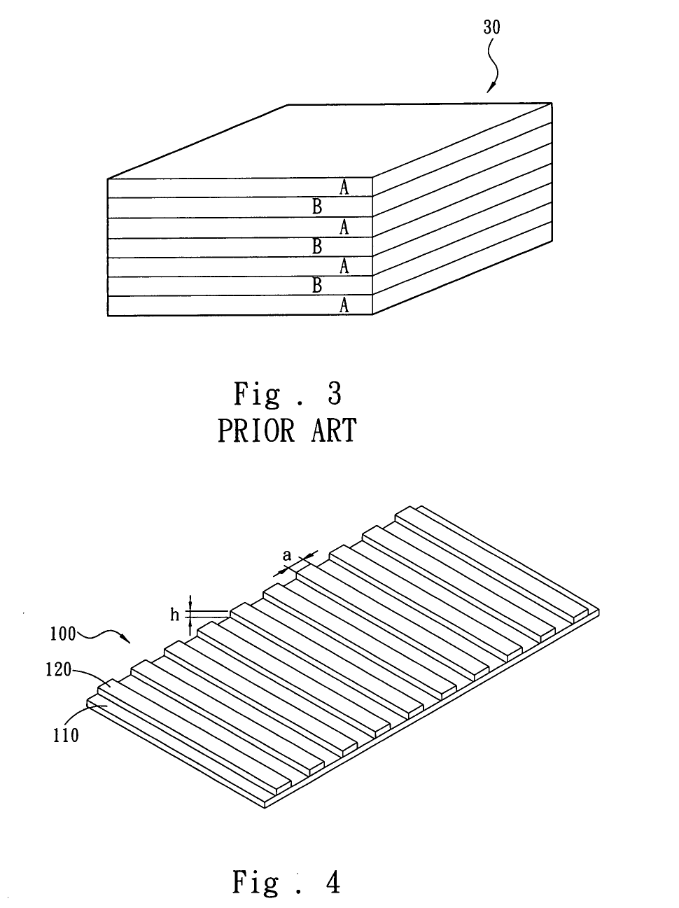

### DETAILED DESCRIPTION OF THE PREFERRED EMBODIMENTS

Below, the technical contents of the present invention are to be described in detail with the embodiments. However, it should be noted that the embodiments are not intended to limit the scope of the present invention but only used to exemplify the present invention.

Refer to FIG. 4 a diagram schematically showing the structure of the plasma reflective polarizer according to the present invention. The plasma reflective polarizer 100 comprises a transparent substrate 110 and a metal-line film 120. The metal-line film 120 is formed via periodically disposing metal lines on the transparent substrate 110. As the transparent substrate 110 is only used to support the metal-line film 120, it needs only mechanical properties and transparency. Alternatively, the plasma reflective polarizer 100 of the present invention comprises a plurality of transparent substrates 110 stacked one above one; each transparent substrate 110 has a metal-line film 120. Similarly, the metal-line film 120 is formed via periodically disposing metal lines on the transparent substrate 110.

The material of the metal-line film 120 is selected from the group consisting of gold, silver, copper and aluminum. The metal-line film 120 has a thickness (h) of between 50 and 300 nm. The spacing (a) between two neighboring metal lines is between 50 and 500 nm.

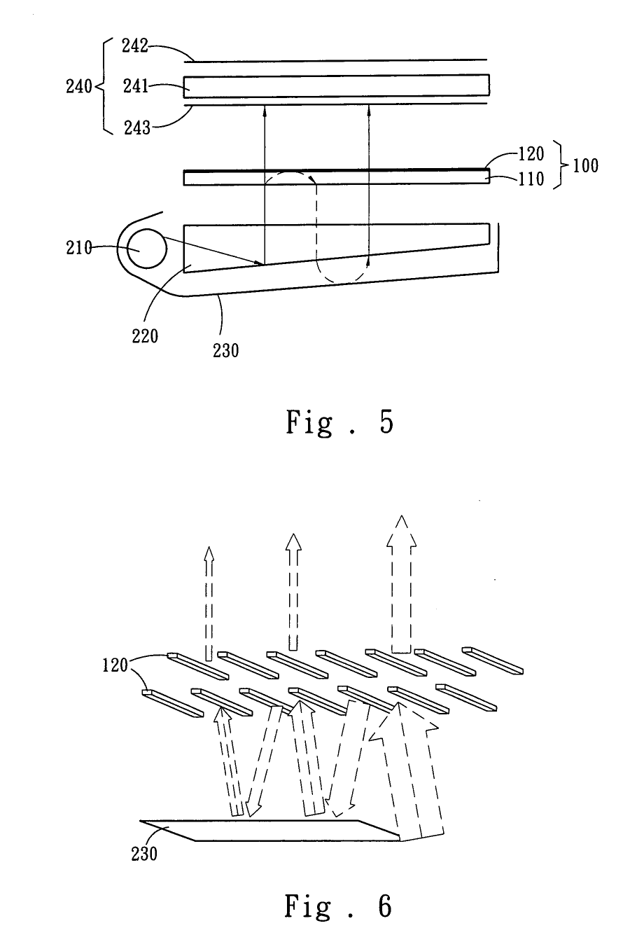

Refer to FIG. 5 a diagram schematically showing that the present invention is applied to an edge-light backlight module. In the application to the edge-light backlight module, the present invention is used to replace the Dual Brightness Enhancement Film disclosed in the U.S. Pat. No. 5,828,488. In a transmissive LCD panel 240, a liquid crystal layer 241 is clamped by a first polarizer 243 and a second polarizer 242 to generate the change of brightness, and the polarization directions of the first polarizer 243 and the second polarizer 242 are perpendicular to each other. One half of the non-polarized light generated by a light source 210 will be absorbed when passing through the first polarizer 243. Thus, the light efficiency is very low. The development of the polarization conversion technology is to solve the problem to promote the efficiency of backlight and reduce the power consumption of LCD. The polarization conversion technology for backlight is using a reflective polarizer to separate light emitted by the light source 210 into light penetrating the LCD panel 240 and light not penetrating the LCD panel 240. Then, the reflected light is converted into useful polarized light by a reflector 230 to enhance brightness. The backlight module also comprises a light guide plate 220, which guides light propagation, promotes brightness and homogenizes brightness; a light source 210 at the thicker end of the light guide plate 220; and a reflector 230 reflecting the leakage light back to the light guide plate 220 to promote light efficiency. At present, the light source 210 is usually CCFL (Cold Cathode Fluorescent Lamp) or LED (Light Emitting Diode). Then, light enters the plasma reflective polarizer 100 of the present invention. The plasma reflective polarizer 100 separates the output light into P-polarized light and S-polarized light. After reflection, the S-polarized light becomes P-polarized light, which can pass through the polarizer of the LCD panel 240.

Refer to FIG. 6. In each incidence of light, one half of light (not shown in the drawing) will penetrate the plasma reflective polarizer 100. Because of the electromagnetic-wave polarization induced by the metal-line film 120 and the special electromagnetic effect-plasma frequency phenomenon of metallic materials, when the frequency of an electromagnetic wave is higher than that of plasma, the electromagnetic wave will penetrate the metal-line film 120; when the frequency of an electromagnetic wave is lower than that of plasma, the electromagnetic wave will not penetrate the metal-line film 120. Therefore, the plasma reflective polarizer 100 itself can function as a high-pass filter. Besides, the metal-line film 120 can reflect the light that does not penetrate. The light reflected by the metal-line film 120 is reflected once again by the reflector 230 and polarized by the metal-line film 120 and then used by the LCD panel 240. Thereby, the overall brightness can be increased by over 60%.

In comparison with the prismatic method, the polarization conversion technology of the present invention not only can increase the brightness in the direction vertical to the panel but also can increase the brightness over a large viewing angle. Besides, the plasma reflective polarizer of the present invention is a simple structure formed of a common transparent and a metal-line film. Therefore, the plasma reflective polarizer 100 of the present invention has the advantages of low cost, superior mechanical properties, and high light-enhancing effect.

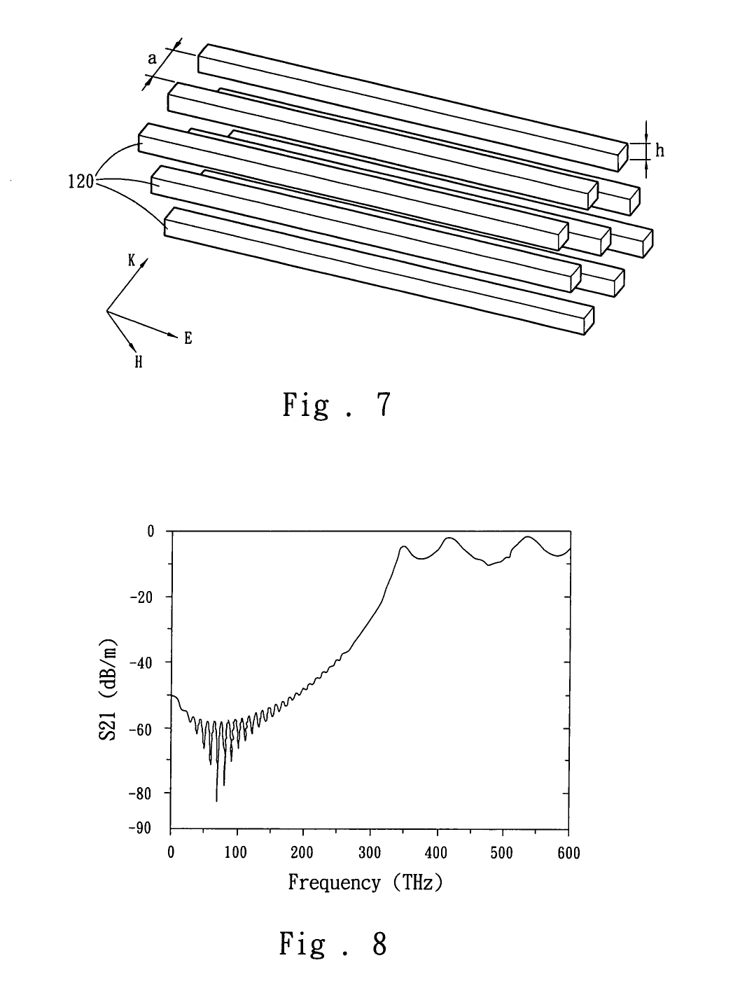

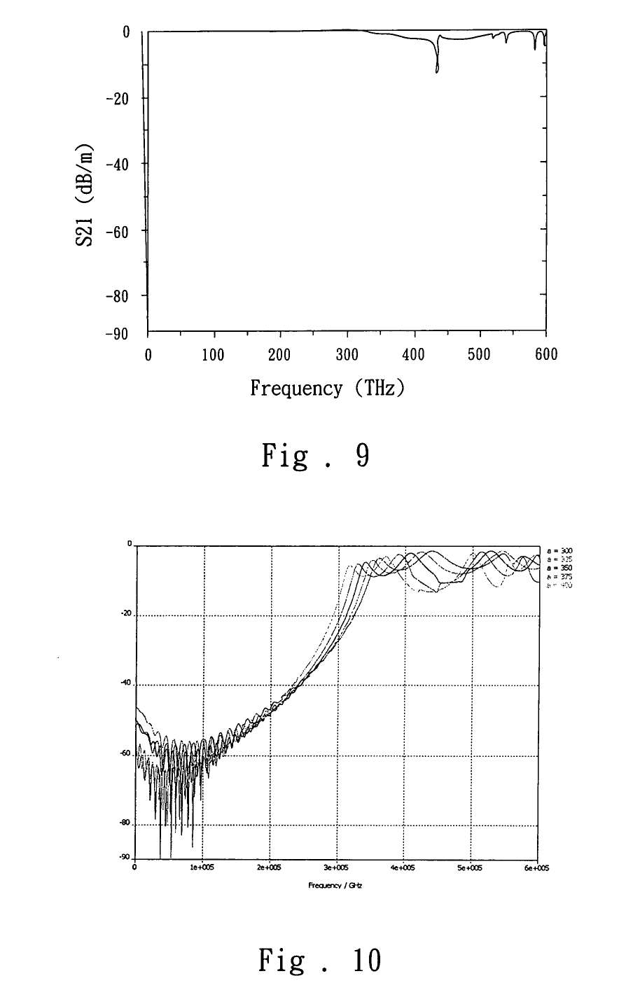

Below is shown the simulation of the light penetration capability in the plasma reflective polarizer 100 of the present invention. Refer to FIG. 7. A triple layer structure plasma reflective polarizer is used in the simulation, wherein the metal-line film 120 is made of gold, and the metal line has a thickness (h) of 100 nm, and the spacing between two neighboring metal lines (a) is 240 nm. The penetration capability is measured in the case that the electric field (E) of light is parallel to the metal lines and the case that the electric field (E) of light is vertical to the metal lines. As shown in FIG. 8, in the case that the electric field (E) of light is parallel to the metal lines of the metal-line film 120, when the electromagnetic wave has a low frequency, it cannot penetrate the metal-line film 120; however, when the electromagnetic wave has a high frequency (higher than the frequency of plasma), it can penetrate the metal-line film 120. As shown in FIG. 9, in the case that the electric field (E) of light is vertical to the metal lines of the metal-line film 120, the electromagnetic wave can penetrate the metal-line film 120 at any frequency. Thus, from the abovementioned simulation, it is known that the metal-line film 120 can effectively identify the polarization direction of the electric field when the electromagnetic wave has a frequency lower than that of plasma.

As shown in FIG. 10, in the cases that the spacing (a) between two neighboring metal lines are respectively 300 nm, 325 nm, 350 nm, 375 nm and 400 nm with the other parameters unchanged, the frequency of the light that can penetrate is decreased with the increase of the spacing (a). Thus, the plasma reflective polarizer of the present invention can be adapted to different light sources via merely adjusting the structural dimensions thereof.

Those described above are the preferred embodiments to exemplify the present invention. However, it is not intended to limit the scope of the present invention. Any equivalent modification and variation according to the spirit of the present invention is to be also included within scope of the present invention, which is based on the claims stated below.

What is claimed is:

1. A plasma reflective polarizer, comprising the following components:
a transparent substrate; and
a metal-line film formed via periodically disposing metal lines on said transparent substrate.

2. The plasma reflective polarizer according to claim 1, wherein the material of said metal-line film is selected from the group consisting of gold, silver, copper and aluminum.

3. The plasma reflective polarizer according to claim 1, wherein the thickness of said metal-line film is between 50 and 300 nm.

4. The plasma reflective polarizer according to claim 1, wherein the spacing between two neighboring said metal lines is between 50 and 500 nm.

5. A plasma reflective polarizer, comprising the following components:
a plurality of transparent substrates stacked one above one; and
a plurality of metal-line films,
wherein each said transparent substrate has one said metal-line film, and said metal-line film is formed via periodically disposing metal lines on said transparent substrate.

6. The plasma reflective polarizer according to claim 5, wherein the material of said metal-line film is selected from the group consisting of gold, silver, copper and aluminum.

7. The plasma reflective polarizer according to claim 5, wherein the thickness of said metal-line film is between 50 and 300 nm.

8. The plasma reflective polarizer according to claim 5, wherein the spacing between two neighboring said metal lines is between 50 and 500 nm.
